(19) United States
(12) Patent Application Publication
(10) Pub. No.: US 2023/0231794 A1
(43) Pub. Date: Jul. 20, 2023

(54) INFORMATION PROCESSING DEVICE, VEHICLE, INFORMATION PROCESSING METHOD, AND STORAGE MEDIUM

(71) Applicant: TOYOTA JIDOSHA KABUSHIKI KAISHA, Toyota-shi (JP)

(72) Inventor: Masatoshi MATSUMOTO, Hamamatsu-shi (JP)

(73) Assignee: TOYOTA JIDOSHA KABUSHIKI KAISHA, Toyota-shi (JP)

(21) Appl. No.: 18/061,015

(22) Filed: Dec. 2, 2022

(30) Foreign Application Priority Data
Jan. 17, 2022 (JP) 2022-005321

(51) Int. Cl. H04L 43/50

(52) U.S. Cl. CPC H04L 43/50

(57) ABSTRACT

An information processing device includes: a memory; and a processor coupled to the memory, the processor being configured to: detect a communication anomaly of communication in a network, based on a predetermined rule, detect a change in a communication specification in the network, and determine whether or not there is an anomaly in the communication based on whether or not a first frequency with which the communication anomaly is detected in a first period of time that is from a first timing until a second timing that is after the first timing, is less than a second frequency with which the communication anomaly is detected in a second period of time that is from the second timing onward, the first timing being on or after a time at which the change in the communication specification is detected.

### CROSS-REFERENCE TO RELATED APPLICATION

This application is based on and claims priority under 35 USC 119 from Japanese Patent Application No. 2022-005321 filed on Jan. 17, 2022, the disclosure of which is incorporated by reference herein.

### BACKGROUND

### Technical Field

The present disclosure relates to an information processing device, a vehicle, an information processing method, and a storage medium.

### Related Art

Japanese Patent Application Laid-Open (JP-A) No. 2021-72582 discloses the following technology. Namely, a communication anomaly detection section determines a communication anomaly of data received by a CAN communication section, based on a detection rule. An erroneous detection learning section compares the type of data determined by the communication anomaly detection section to be a communication anomaly during the current trip with the type of data determined by the communication anomaly detection section to be a communication anomaly during the previous trip. The erroneous detection learning section then sets the type of data determined to be a communication anomaly in each of the two trips, the current trip and the previous trip, as a suppression target to which the determination of a communication anomaly by the communication anomaly detection section is suppressed.

However, in the technology described in JP-A No. 2021-72582, in a case in which communication that does not conform to a rule occurs with high frequency due to a cyber attack or the like, there is a possibility of this being erroneously determined as conforming to a correct communication specification rather than an anomaly, and therefore, the detection accuracy of an anomaly may deteriorate.

### SUMMARY

The present disclosure has been made in consideration of the aforementioned circumstances, and provides an information processing device, a vehicle, an information processing method, and a non-transitory storage medium capable of suppressing deterioration in the accuracy of anomaly detection even in a case in which communication that does not conform to a rule has occurred frequently.

An information processing device according to a first aspect includes: a memory; and a processor coupled to the memory, the processor being configured to: detect a communication anomaly of communication in a network, based on a predetermined rule, detect a change in a communication specification in the network, and determine whether or not there is an anomaly in the communication based on whether or not a first frequency with which the communication anomaly is detected in a first period of time that is from a first timing until a second timing that is after the first timing, is less than a second frequency with which the communication anomaly is detected in a second period of time that is from the second timing onward, the first timing being on or after a time at which the change in the communication specification is detected.

Communication anomalies caused by a change of a communication specification in a network (that is, communication anomalies that do not conform to the changed communication specification) increase in frequency immediately after the communication specification in the network has been changed. On the other hand, communication anomalies caused by fraud, such as cyber attacks, increase in frequency at a timing that is unrelated to a change in the communication specification in a network.

Based on the above, in the first aspect, it is determined whether or not there is an anomaly in the communication based on whether or not a first frequency with which the communication anomaly is detected in a first period of time that is from a first timing, which is on or after the time at which the change in the communication specification is detected, until a second timing that is after the first timing, is less than a second frequency with which the communication anomaly is detected in a second period of time that is from the second timing onward. This enables deterioration in the accuracy of anomaly detection to be suppressed even in a case in which communication that does not conform to a rule has occurred frequently.

A second aspect is the first aspect, wherein the processor is configured to: determine that there is no anomaly in a case in which the first frequency with which the communication anomaly is detected in the first period of time exceeds a first threshold value, and determine that there is an anomaly in a case in which the second frequency with which the communication anomaly is detected in the second period of time after the first period of time exceeds a second threshold value that is equal to or greater than the first threshold value.

According to the second aspect, even in a case in which communication that does not conform to a rule has occurred frequently, deterioration in the accuracy of anomaly detection may be suppressed by simple processing in which the frequencies with which a communication anomaly is detected are compared with the threshold values.

A third aspect is the first aspect or the second aspect, wherein the processor is configured to: determine that there is no anomaly in a case in which the first frequency with which the communication anomaly is detected on or after the first timing exceeds a first threshold value, the first timing being immediately after the change in the communication specification is detected, and determine that there is an anomaly in a case in which the second frequency with which the communication anomaly is detected on or after the second timing exceeds a second threshold value that is equal to or greater than the first threshold value.

According to the third aspect, similarly to the second aspect, even in a case in which communication that does not conform to a rule has occurred frequently, deterioration in the accuracy of anomaly detection may be suppressed by simple processing in which the frequencies with which a communication anomaly is detected are compared with the threshold values.

A fourth aspect is any one of the first aspect to the third aspect, wherein the determination section determines whether or not there is a significant difference between the first frequency with which the communication anomaly is detected by the first detection section in the first period of time and the second frequency with which the communication anomaly is detected by the first detection section the second period of time, by a t-test or a u-test.

According to the fourth aspect, it is possible to accurately determine whether or not there is a significant difference between the first frequency with which a communication anomaly is detected in the first period of time and the second frequency with which a communication anomaly is detected in the second period of time, thereby enabling the accuracy of anomaly detection to be improved.

A fifth aspect is any one of the first aspect to the fourth aspect, wherein the predetermined rule is an identical rule before and after the change in the communication specification is detected by the second detection section.

In the fifth aspect, since the predetermined rules may be shared in vehicles installed with different network communication specifications in the network, costs required for creating predetermined rules and the like may be reduced.

A sixth aspect is any one of the first aspect to the fifth aspect, further including a setting section that sets information relating to communication not determined to be an anomaly by the determination section as a suppression target to which detection of a communication anomaly is suppressed.

In the sixth aspect, among the predetermined rules, information relating to communication which do not conform to the communication specification of the network is learned as a suppression target. This enables the detection accuracy of an anomaly to be improved without creating detection rules for each vehicle having a different communication specification of the network.

A seventh aspect is any one of the first aspect to the sixth aspect, wherein the second detection section detects, as the change in the communication specification, replacement of an ECU that is included in the network or an update of a program that is stored in the ECU.

The replacement of an ECU that is included in a network and the update of a program that is stored in the ECU (also referred to as reprogramming) are events that may involve a change in the communication specification in the network. The seventh aspect is capable of reliably detecting a change in the communication specification in the network by detecting these events.

An eighth aspect is the first aspect, wherein the second timing is one of: a timing that is prior to a present time by a predetermined period of time, a timing that is prior to the present time by an amount of time it takes for a predetermined number of frames to be communicated in the network, or a timing that is prior to the present time by an amount of time it takes for a number of trips to reach a first predetermined value.

According to the eighth aspect, the second timing, which is the start timing of the second period of time, may be appropriately set.

A ninth aspect is the first aspect, wherein the first timing is one of: a timing immediately after the change in the communication specification is detected by the second detection section, a timing that is prior to the second timing by a predetermined period of time, a timing that is prior to the second timing by an amount of time it takes for a predetermined number of frames to be communicated in the network, or a timing that is prior to the second timing by an amount of time it takes for a number of trips to reach a second predetermined value.

According to the ninth aspect, the first timing, which is the start timing of the first period of time, may be appropriately set.

A vehicle according to a tenth aspect includes the information processing device according to any one of the first aspect to the ninth aspect.

In the tenth aspect, the information processing device of any one of the first aspect to the ninth aspect is installed, and therefore, similarly to the first aspect, it is possible to suppress deterioration in the accuracy of anomaly detection even in a case in which communication that does not conform to a rule has occurred frequently.

An information processing method according to an eleventh aspect includes: detecting a communication anomaly of communication in a network, based on a predetermined rule, detecting a change in a communication specification in the network, and determining whether or not there is an anomaly in the communication based on whether or not a first frequency with which the communication anomaly is detected in a first period of time that is from a first timing until a second timing that is after the first timing, is less than a second frequency with which the communication anomaly is detected in a second period of time that is from the second timing onward, the first timing being on or after a time at which the change in the communication specification is detected.

Similarly to the first aspect, the eleventh aspect enables deterioration in the accuracy of anomaly detection to be suppressed even in a case in which communication that does not conform to a rule has occurred frequently.

A twelfth aspect is a non-transitory storage medium storing a program executable by a computer to perform information processing, the information processing including: detecting a communication anomaly of communication in a network, based on a predetermined rule, detecting a change in a communication specification in the network, and determining whether or not there is an anomaly in the communication based on whether or not a first frequency with which the communication anomaly is detected in a first period of time that is from a first timing until a second timing that is after the first timing, is less than a second frequency with which the communication anomaly is detected in a second period of time that is from the second timing onward, the first timing being on or after a time at which the change in the communication specification is detected.

Similarly to the first aspect, the twelfth aspect enables deterioration in the accuracy of anomaly detection to be suppressed even in a case in which communication that does not conform to a rule has occurred frequently.

The present disclosure enables deterioration in the accuracy of anomaly detection to be suppressed even in a case in which communication that does not conform to a rule has occurred frequently.

### BRIEF DESCRIPTION OF THE DRAWINGS

FIG. 1 is a block diagram illustrating a schematic configuration of an onboard system according to an exemplary embodiment.

FIG. 2 is a functional block diagram of a communication monitoring ECU.

FIG. 3 is a flowchart illustrating anomaly detection processing executed by the communication monitoring ECU.

FIG. 4 is a table illustrating an example of erroneous detection learning results.

FIG. 5 is a flowchart illustrating erroneous detection learning processing according to the first exemplary embodiment.

FIG. 6 is an explanatory diagram illustrating an example of an anomaly detection occurrence pattern and an example of a determination result obtained by erroneous detection learning processing.

FIG. 7 is an explanatory diagram illustrating an example of an anomaly detection occurrence pattern and an example of a determination result obtained by erroneous detection learning processing.

FIG. 8 is an explanatory diagram illustrating an example of an anomaly detection occurrence pattern and an example of a determination result obtained by erroneous detection learning processing.

FIG. 9 is a flowchart illustrating erroneous detection learning processing according to the second exemplary embodiment.

FIG. 10 is an explanatory diagram illustrating an example of an anomaly detection occurrence pattern and an example of a determination result obtained by erroneous detection learning processing.

FIG. 11 is a table illustrating another example of erroneous detection learning results.

FIG. 12 is a table illustrating another example of erroneous detection learning results.

### DETAILED DESCRIPTION

An exemplary embodiment of the present disclosure will be explained in detail below with reference to the drawings.

### First Exemplary Embodiment

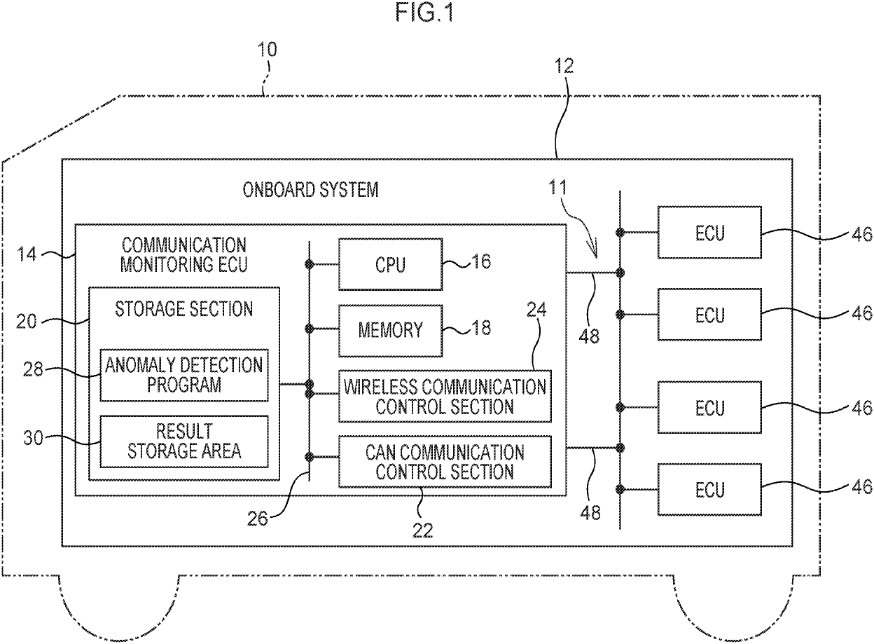

An onboard system 12 illustrated in FIG. 1 is installed at a vehicle 10, and is provided with a network 11. The network 11 of the onboard system 12 includes a single communication monitoring electronic control unit (ECU) 14 and plural ECUs 46 with mutually different functionality. Note that the vehicle 10 is an example of a vehicle according to the present disclosure.

The plural ECUs 46 are each connected to the communication monitoring ECU 14 via a controller area network (CAN) communication bus 48, and CAN communication conforming to a communication specification of the network 11 of the onboard system 12 is performed between the communication monitoring ECU 14 and the ECUs 46. Note that although FIG. 1 illustrates four ECUs 46, the number of ECUs 46 included in the onboard system 12 is not limited to this. Further, although not illustrated in the drawings, a gateway ECU is also provided in the network 11 of the onboard system 12.

The communication monitoring ECU 14 includes a central processing unit (CPU) 16, memory 18 such as read only memory (ROM) or random access memory (RAM), a non-volatile storage section 20 such as a hard disk drive (HDD) or solid state drive (SSD), a CAN communication control section 22, and a wireless communication control section 24. The CPU 16, the memory 18, the storage section 20, the CAN communication control section 22, and the wireless communication control section 24 are communicably connected to each other via an internal bus 26.

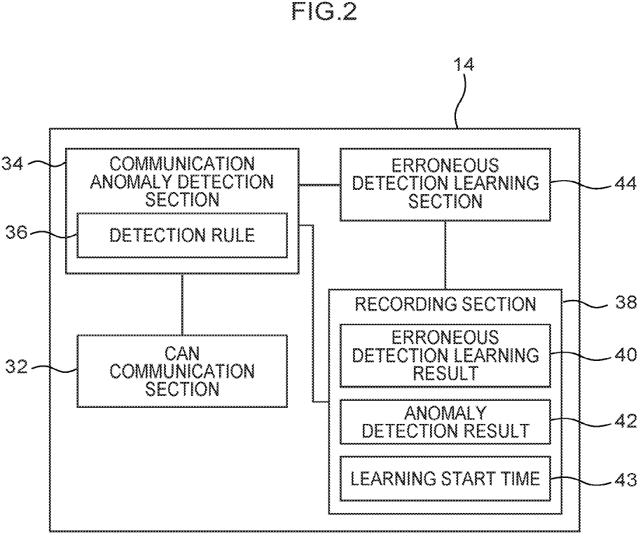

An anomaly detection program 28 is stored in the storage section 20, and a result storage area 30 is provided at the storage section 20. The communication monitoring ECU 14 functions as a CAN communication section 32, a communication anomaly detection section 34, an erroneous detection learning section 44, and a recording section 38 illustrated in FIG. 2 by reading the anomaly detection program 28 from the storage section 20, loading the anomaly detection program 28 in the memory 18, and the anomaly detection program 28 that has been loaded in the memory 18 being executed by the CPU 16. The communication monitoring ECU 14 thereby functions as an example of an information processing device according to the present disclosure. Note that the anomaly detection program 28 is an example of a program according to the present disclosure.

The CAN communication section 32 cooperates with the CAN communication control section 22 to receive CAN communication frames from the CAN communication bus 48. The communication anomaly detection section 34 determines whether a CAN communication frame received by the CAN communication section 32 to be a communication anomaly based on detection rules 36 that are predetermined based on the communication specification of the network 11 of the onboard system 12. In the present exemplary embodiment, the following three types of communication anomalies are detected by the communication anomaly detection section 34.

Fraudulent ID determination: a CAN communication frame with an ID that is not defined in the detection rules 36 is determined to be a communication anomaly caused by fraud such as a cyber attack.

Fraudulent DLC determination: a CAN communication frame with a DLC that is not defined in the detection rules 36 is determined to be a communication anomaly caused by fraud such as a cyber attack.

Fraudulent cycle determination: a CAN communication frame with a transmission cycle that differs from the detection rules 36 is determined to be a communication anomaly caused by fraud such as a cyber attack.

Note that in the present exemplary embodiment, although vehicles 10 in which the communication specifications of the network 11 of the onboard system 12 are not the same are mixed among plural vehicles 10 installed with the onboard system 12, the detection rules 36 are rules that are common to plural types of vehicles 10 in which the communication specifications of the network 11 of the onboard system 12 are not the same. The detection rules 36 are an example of a predetermined rule in the present disclosure, and the communication anomaly detection section 34 is an example of a first detection section in the present disclosure.

The erroneous detection learning section 44 detects a change in the communication specification in the network 11 of the onboard system 12. In the present exemplary embodiment, as an example of a change in the communication specification in the network 11, the erroneous detection learning section 44 detects replacement of the ECU 46 that is included in the network 11 and update (reprogramming) of a program that is stored in a storage section (not illustrated) of the ECU 46. Moreover, in a case in which the erroneous detection learning section 44 has detected replacement or reprogramming of the ECU 46, a learning start time 43 that is recorded in the recording section 38 is reset to the present time. The erroneous detection learning section 44 that performs this processing is an example of a second detection section in the present disclosure.

Note that in the present exemplary embodiment, when replacing the ECU 46, a service person who replaced the ECU 46 uses a diagnostic tool (Global TechStream®: GTS) so as to input a request to reset the learning start time 43 to the erroneous detection learning section 44. Moreover, in the present exemplary embodiment, when reprogramming the ECU 46, in a case in which the reprogramming authentication has been successful by the gateway ECU that performed the reprogramming authentication, a request to reset the learning start time 43 is input to the erroneous detection learning section 44. The erroneous detection learning section 44 detects that replacement or reprogramming of the ECU 46 has been performed in a case in which the above-described request to reset the learning start time 43 has been input, and resets the learning start time 43.

The erroneous detection learning section 44 determines whether a result determined to be a communication anomaly by the communication anomaly detection section 34 is an anomaly due to fraud such as a cyber attack or an erroneous detection of an anomaly caused by a change in the communication specification. More specifically, based on whether or not a first frequency with which the communication anomaly detection section 34 detects a communication anomaly during a first period of time that is from a first timing, which is on or after the time at which a change in the communication specification in the network 11 of the onboard system 12 is detected, until a second timing that is after the first timing, is less than a second frequency with which the communication anomaly detection section 34 detects a communication anomaly during a second period of time that is from the second timing onward, the erroneous detection learning section 44 determines whether or not the anomaly is caused by fraud such as a cyber attack. The erroneous detection learning section 44 that performs this processing is an example of a determination section in the present disclosure.

The erroneous detection learning section 44 sets, as an erroneous detection learning result 40, information relating to a communication that is determined to be an erroneous detection of an anomaly caused by a change in the communication specification, from among the results determined to be communication anomalies by the communication anomaly detection section 34, as a suppression target to which the determination of a communication anomaly by the communication anomaly detection section 34 is suppressed (i.e., prevented or avoided). The erroneous detection learning section 44 that performs this processing is an example of a setting section in the present disclosure.

The recording section 38 records the detection result (i.e., anomaly detection result 42 of past x + y number of trips) from the erroneous detection learning section 44, the learning result (i.e., erroneous detection learning result 40) from the erroneous detection learning section 44, and the learning start time 43 that is reset by the erroneous detection learning section 44 in the result storage area 30. x is an example of a second predetermined value in the present disclosure, and y is an example of a first predetermined value in the present disclosure. As a specific example of x and y, a value of 10 or less may be set, and more specifically, a value of about 2 to 4 may be set as an example.

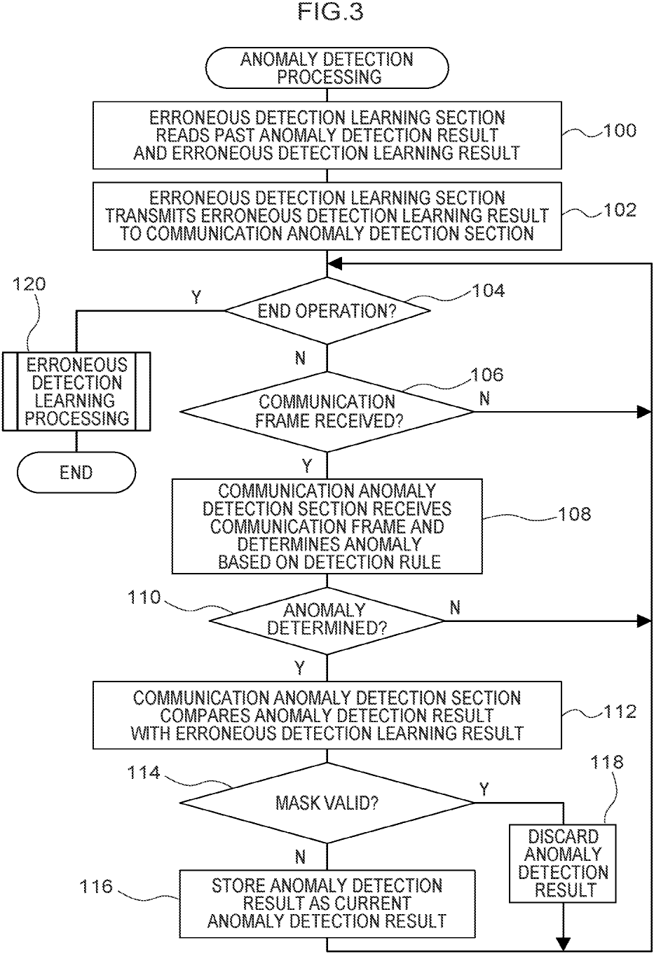

Next, explanation follows regarding operation of the present exemplary embodiment, with reference to FIG. 3, regarding anomaly detection processing executed by the communication monitoring ECU 14 at a timing when, for example, an ignition switch of the vehicle 10 is turned on.

At step 100 of the anomaly detection processing, the erroneous detection learning section 44 reads, from the recording section 38, the past anomaly detection result 42 and the erroneous detection learning result 40 which are recorded in the recording section 38. At step 102, the erroneous detection learning section 44 transmits the erroneous detection learning result 40, which is read from the recording section 38 at step 100, to the communication anomaly detection section 34.

At step 104, the CAN communication section 32 determines whether or not to end operation, triggered by, for example, the ignition switch of the vehicle 10 being turned off. In a case in which the determination of step 104 is negative, the processing transitions to step 106. At step 106, the CAN communication section 32 determines whether or not a CAN communication frame has been received from the ECU 46. In a case in which the determination of step 106 is negative, the processing returns to step 104, and steps 104 and 106 are repeated until the determination of step 104 or step 106 is affirmative.

After the CAN communication section 32 receives a CAN communication frame from the ECU 46, the determination of step 106 becomes affirmative, and the processing transitions to step 108. At step 108, the communication anomaly detection section 34 receives, from the CAN communication section 32, the CAN communication frame received by the CAN communication section 32, and determines whether or not there is a communication anomaly based on the detection rules 36 (i.e., fraudulent ID determination/fraudulent DLC determination/fraudulent cycle determination).

At step 110, the communication anomaly detection section 34 determines whether or not a communication anomaly has been determined at step 108. In a case in which the received CAN communication frame does not correspond to any of a fraudulent ID determination, a fraudulent DLC determination, or a fraudulent cycle determination, the determination of step 110 is negative, and the processing returns to step 104.

In a case in which the received CAN communication frame is determined to be a communication anomaly in at least one of a fraudulent ID determination, a fraudulent DLC determination or a fraudulent cycle determination, the determination of step 110 is affirmative, and the processing transitions to step 112. At step 112, the communication anomaly detection section 34 compares the current anomaly detection result with the erroneous detection learning result 40.

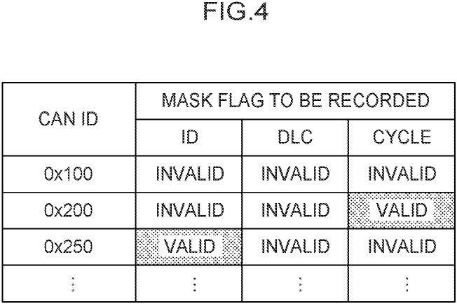

As illustrated in FIG. 4 for example, the erroneous detection learning result 40 according to the present exemplary embodiment is configured such that a flag indicating whether or not a mask for determination as a communication anomaly is valid (with a mask) or invalid (without a mask) is set for each type of data, i.e., ID, DLC, or cycle, in a CAN ID. In the present exemplary embodiment, all of the initial values of the masks (flags) are set to “invalid”, and in a case in which it is determined that an erroneous detection of a communication anomaly has occurred, the mask (flag) for the corresponding CAN ID and the type is changed to “valid”.

At step 114, based on the comparison result at step 112, the communication anomaly detection section 34 determines whether or not the mask (flag) corresponding to the CAN ID and the type of data that is determined to be a communication anomaly (ID/DLC/cycle) are set to “valid”. In a case in which the determination of step 114 is negative, the processing transitions to step 116, and at step 116, the communication anomaly detection section 34 stores the current anomaly detection result as the anomaly detection result of the current trip. In a case in which the determination of step 114 is affirmative, the processing advances to step 118, and at step 118, the communication anomaly detection section 34 discards the current anomaly detection result.

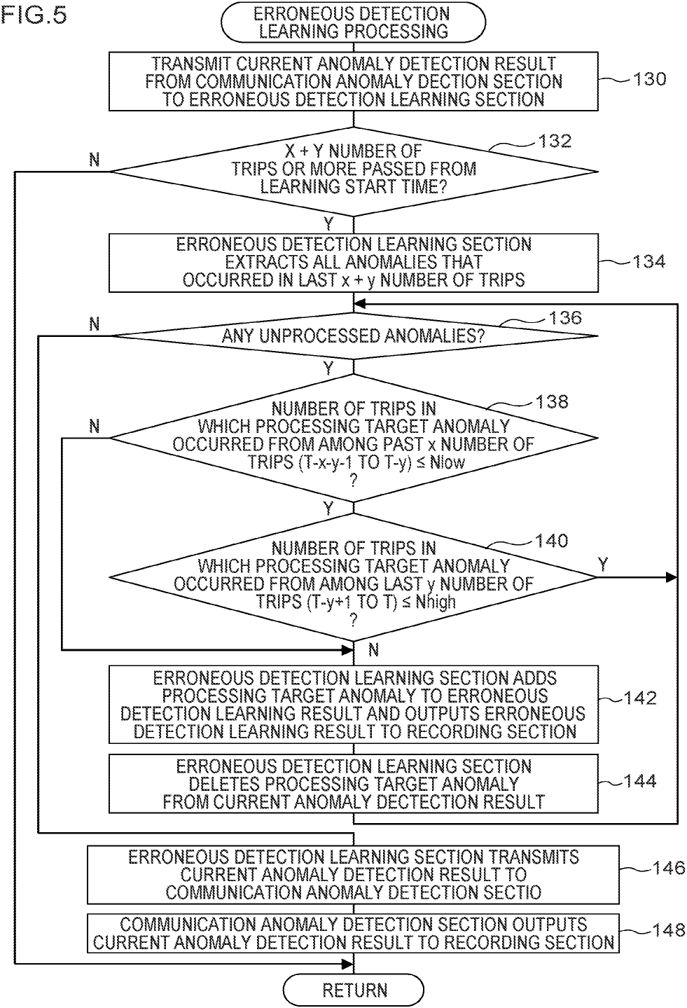

In a case in which the determination of step 104 is affirmative, the processing transitions to step 120, and erroneous detection learning processing is performed at step 120. Details of the erroneous detection learning processing performed at step 120 are described below with reference to FIG. 5.

At step 130 of the erroneous detection learning processing, the communication anomaly detection section 34 transmits the anomaly detection result of the current trip to the erroneous detection learning section 44. Further, at step 132, the erroneous detection learning section 44 determines whether or not x + y number of trips or more have passed from the learning start time 43. In a case in which the number of trips from the learning start time 43 is less than x + y times, the determination of step 132 is negative, and the erroneous detection learning processing is ended.

In a case in which the number of trips from the learning start time 43 is x + y times or more, the determination of step 132 is affirmative, and the processing transitions to step 134. At step 134, the erroneous detection learning section 44 extracts all anomalies for which the communication anomaly detection section 34 has determined that a communication anomaly has occurred in the last x + y number of trips. At step 136, the erroneous detection learning section 44 determines whether or not there are any anomalies, among the anomalies extracted at step 134, for which the processing at step 138 and subsequent steps has not been executed. In a case in which the determination of step 136 is affirmative, one anomaly which is a processing target is selected from the anomalies extracted at step 134, and the processing transitions to step 138.

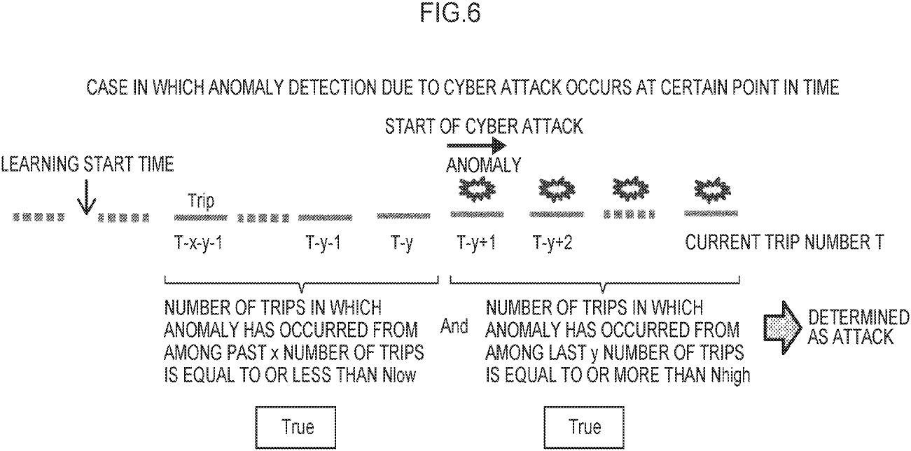

At step 138, the erroneous detection learning section 44 counts the number of trips in which an anomaly which is a processing target has occurred from among the past x number of trips (as illustrated in FIG. 6, in a case in which the number of the current trip is T, the trips numbered T-x-y-1 to T-y). The erroneous detection learning section 44 then determines whether or not the counted number of trips is equal to or less than a threshold value Nlow. Note that the threshold value Nlow is an example of a first threshold value in the present disclosure. In a case in which the determination of step 138 is affirmative, the processing transitions to step 140.

At step 140, the erroneous detection learning section 44 counts the number of trips in which an anomaly which is a processing target has occurred from among the last y number of trips (as illustrated in FIG. 6, in a case in which the number of the current trip is T, the trips numbered T-y+1 to T). The erroneous detection learning section 44 then determines whether or not the counted number of trips is equal to or greater than a threshold value Nhigh. Note that the threshold value Nhigh is an example of a second threshold value in the present disclosure, and the threshold value Nhigh ≥ the threshold value Nlow. That is, the threshold value Nhigh may be a value that is equal to threshold value Nlow or a value that is greater than the threshold value Nlow.

Communication anomalies caused by fraudulent attacks, such as cyber attacks, occur more frequently at a timing that is unrelated to the timing at which the communication specification in the network 11 is changed (i.e., at the learning start time 43). Accordingly, in a case in which the determination of step 138 is affirmative and the determination of step 140 is also affirmative, it is possible to determine that an anomaly which is a processing target is a communication anomaly caused by fraud such as a cyber attack. Therefore, processing such as recording information indicating that the anomaly of the processing target is an anomaly caused by fraud such as a cyber attack is performed, and the processing returns to step 136.

On the other hand, the occurrence of a communication anomaly caused by a change in the communication specification in the network 11 (a communication anomaly due to not conforming to the communication specification after the change) increases in frequency immediately after the communication specification has been changed in the network 11. Therefore, the determination of step 138 becomes negative or the determination of step 140 becomes negative. In a case in which the determination of step 138 is negative or the determination of step 140 is negative, the processing then transitions to step 142.

Note that in the present exemplary embodiment, since the detection rules 36 are common to plural types of vehicles 10 in which the communication specifications of the network 11 of the onboard system 12 are not the same, there is a possibility that some of the detection rules 36 do not conform to the communication specification of the network 11 of the onboard system 12. In a case in which some of the detection rules 36 do not conform to the communication specification of the network 11 of the onboard system 12, data of the type corresponding to this part of the detection rules 36 will repeatedly determined as a communication anomaly and, similarly to the above, the determination of step 138 becomes negative or the determination of step 140 becomes negative, and the processing transitions to step 142.

At step 142, the erroneous detection learning section 44 adds the anomaly which is the processing target from among the anomaly detection result of the current trip to the erroneous detection learning result 40 (i.e., sets the mask (flag) of the corresponding data type to “valid”). The erroneous detection learning section 44 then outputs the erroneous detection learning result 40 to the recording section 38, and the recording section 38 records the erroneous detection learning result 40 in the result storage area 30. Further, at step 144 the erroneous detection learning section 44 deletes, from the anomaly detection result of the current trip, an anomaly which is a processing target which was added to the erroneous detection learning result 40 from the anomaly detection result of the current trip.

After performing the processing of step 144, the processing returns to step 136. As a result, step 136 to step 144 are repeated until the determination of step 136 is negative. Then, in a case in which the determination of step 136 is negative, the processing transitions to step 146.

At step 146, the erroneous detection learning section 44 transmits the anomaly detection result of the current trip to the communication anomaly detection section 34. Then, at step 148, the communication anomaly detection section 34 outputs the anomaly detection result of the current trip to the recording section 38, and the recording section 38 records, as the anomaly detection result 42, the anomaly detection result of the current trip input from the communication anomaly detection section 34 in the result storage area 30.

As illustrated in FIG. 6 for example, in a case in which an anomaly has occurred due to a cyber attack or the like from a certain point of time on or after the learning start time 43, the determination regarding the number of trips in which an anomaly has occurred among the past x number of trips (step 138) is affirmative. Further, the determination regarding the number of trips in which an anomaly has occurred among the last y number of trips (step 140) is also affirmative, enabling the determination to be made as an anomaly due to a cyber attack or the like (i.e., not determined as an erroneous detection of an anomaly).

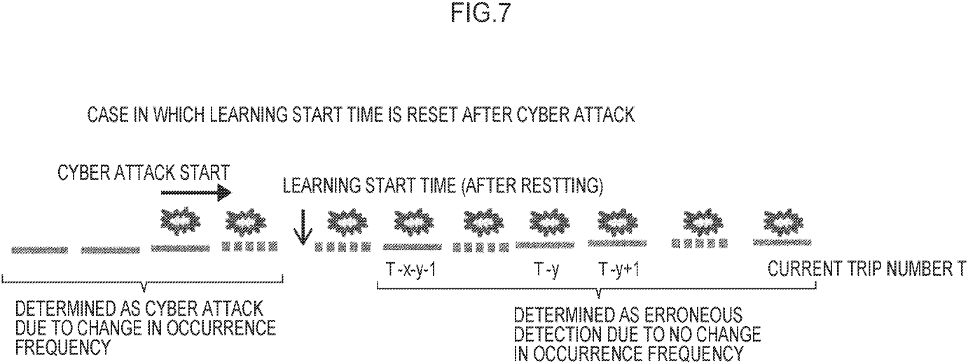

As an example, as illustrated in FIG. 7, in a case in which the learning start time 43 has been reset after a cyber attack, since no clear change has arisen in the frequency of occurrence of anomaly detection since the learning start time 43 has been reset, it is not determined that an anomaly has occurred due to a cyber attack or the like. However, at the start timing of a cyber attack illustrated in FIG. 7, since a clear change has arisen in the frequency of occurrence of anomaly detection prior to the resetting of the learning start time 43, it is possible to determine that an anomaly has occurred due to a cyber attack or the like.

In a case in which anomaly detection has occurred due to a change in the communication specification from the learning start time 43 due to reprogramming of the ECU 46 or the like, the determination regarding the number of trips in which an anomaly has occurred among the past x number of trips (step 138) is negative. This enables determination of an erroneous detection of an anomaly even if the determination regarding the number of trips in which an anomaly has occurred among the last y number of trips is satisfied (step 140).

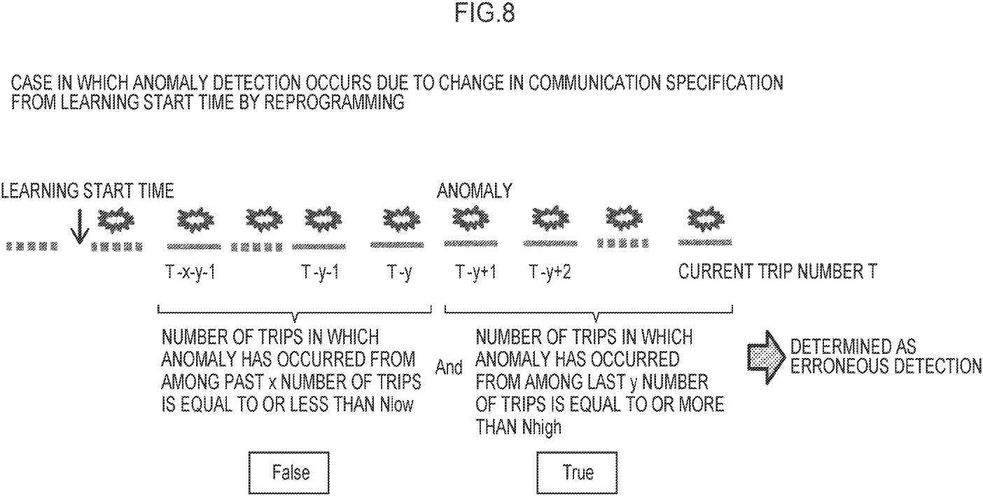

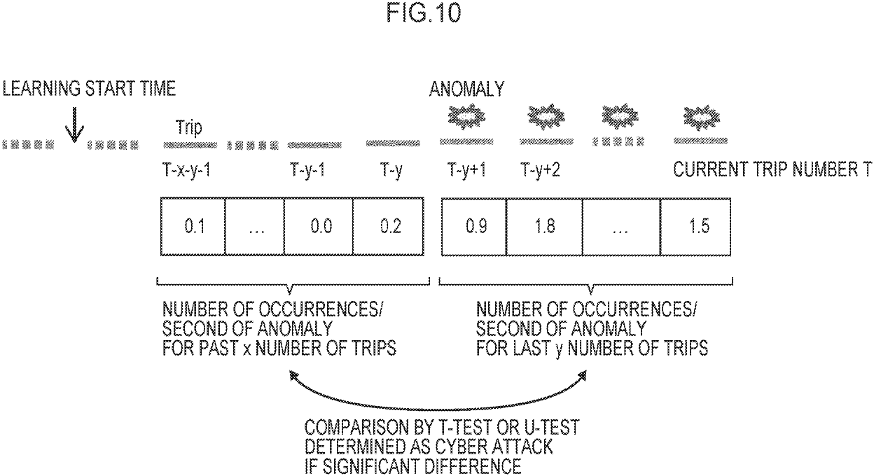

Note that in FIG. 6 to FIG. 8 (and FIG. 10 described later), the start time of the trip numbered T-x-y-1 is an example of the first timing in the present disclosure, and the start time of the trip numbered T-y+1 is an example of the second timing in the present disclosure. Accordingly, in FIG. 6 to FIG. 8 (and FIG. 10 described later), the period of time of the trips numbered T-x-y-1 to T-y is an example of the first period of time in the present disclosure, and the period of time of the trips numbered T-y-1 to T is an example of the second period of time in the present disclosure.

As described above, in the first exemplary embodiment, the communication anomaly detection section 34 of the communication monitoring ECU 14 detects a communication anomaly based on a predetermined rule with respect to communication over the network 11. The erroneous detection learning section 44 detects a change in the communication specification in the network 11. Moreover, the erroneous detection learning section 44 determines whether or not there is an anomaly based on whether or not the frequency (first frequency) with which a communication anomaly is detected by the communication anomaly detection section 34 during a first period of time that is from a first timing, which is on or after a time at which a change in the communication specification in the network 11 is detected, until a second timing that is after the first timing, is less than the frequency (second frequency) with which a communication anomaly is detected by the communication anomaly detection section 34 during a second period of time that is from the second timing onward. This enables preventing deterioration in the accuracy of anomaly detection even in a case in which communication that does not conform to a rule has occurred frequently.

In the first exemplary embodiment, the erroneous detection learning section 44 does not determine that an anomaly has occurred in a case in which the first frequency with which a communication anomaly is detected by the communication anomaly detection section 34 from the first period of time exceeds the first threshold value, and determines that an anomaly has occurred in a case in which the second frequency with which a communication anomaly is detected by the communication anomaly detection section 34 during a second period of time following the first period of time exceeds the second threshold value that is greater than or equal to the first threshold value. This enables preventing deterioration in the accuracy of anomaly detection even in a case in which communication that does not conform to a rule has occurred frequently, by simple processing of comparing the frequencies with which a communication anomaly is detected with threshold values.

In the first exemplary embodiment, the first timing being a time immediately after detection of a change in the communication specification, and the erroneous detection learning section 44 does not determine that an anomaly has occurred in a case in which the first frequency with which a communication anomaly is detected by the communication anomaly detection section 34 from the first timing exceeds the first threshold value, and determines that an anomaly has occurred in a case in which the second frequency with which a communication anomaly is detected by the communication anomaly detection section 34 on or after the second timing exceeds the second threshold value, which is greater than or equal to the first threshold value. This enables deterioration in the accuracy of anomaly detection to be suppressed by simple processing of comparing the frequency with which a communication anomaly is detected with threshold values.

Further, in the first exemplary embodiment, the predetermined rules are the same rules before and after a change in the communication specification is detected by the erroneous detection learning section 44. This enables predetermined rules in the vehicles 10 having different communication specifications for the installed network 11 to be shared, enabling costs required for creating predetermined rules and the like to be reduced.

In the first exemplary embodiment, the erroneous detection learning section 44 sets information relating to communication determined to be an anomaly by the erroneous detection learning section 44 as a suppression target to which detection of a communication anomaly by the communication anomaly detection section 34 is suppressed or inhibited. This enables the detection accuracy of an anomaly to be improved without creating detection rules for each vehicle 10 with a different communication specification for the network 11.

Further, in the first exemplary embodiment, the erroneous detection learning section 44 detects replacement of the ECU 46 that is included in the network 11 or an update of a program that is stored in the ECU 46 as a change in the communication specification. This enables a change in the communication specification in the network 11 to be reliably detected.

Moreover, in the first exemplary embodiment, the second timing is a timing that is prior to the present time by an amount of time it takes for the number of trips to reach the first predetermined value (y in the present exemplary embodiment). This enables the second timing, which is the start timing of the second period of time, to be appropriately set.

Further, in the first exemplary embodiment, the first timing is a timing that is prior to the second timing by an amount of time it takes for the number of trips to reach the second predetermined value (x in the present exemplary embodiment). This enables the first timing, which is the start timing of the first period of time, to be appropriately set.

### Second Exemplary Embodiment

Next, explanation follows regarding a second exemplary embodiment of the present disclosure. Note that since the second exemplary embodiment has a similar configuration as the first exemplary embodiment, the same reference numerals are allocated to the corresponding components, and explanation of the configuration is omitted.

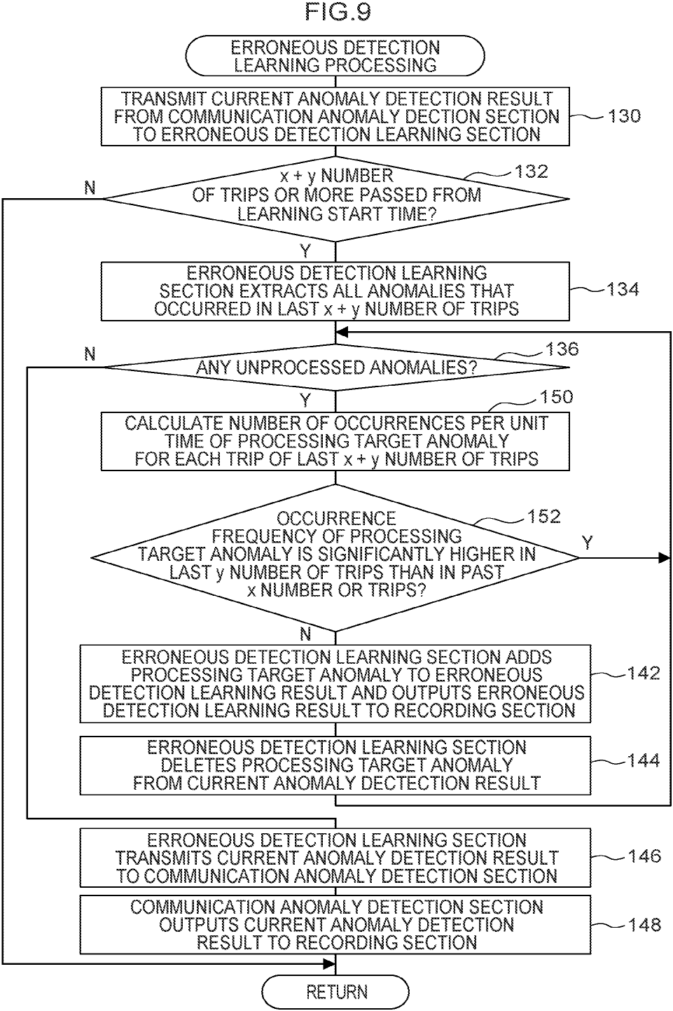

FIG. 9 illustrates erroneous detection learning processing according to the second exemplary embodiment. The erroneous detection learning processing according to the second exemplary embodiment differs from the erroneous detection learning processing described in the first exemplary embodiment (FIG. 5) in that steps 150 and 152 are performed instead of steps 138 and 140.

Namely, at step 150, the erroneous detection learning section 44 calculates the number of occurrences (occurrence frequency) per unit time of an anomaly which is a processing target for each of the last x + y number of trips. As an example, FIG. 10 illustrates an example of the number of occurrences, per unit time, of an anomaly which is a processing target for each trip, with numerical values such as “0.1”, “0.0”, and “0.2”.

Next, at step 152, based on the calculation result of step 150, the erroneous detection learning section 44 applies a t-test or a u-test to determine whether or not the frequency of occurrence of an anomaly which is a processing target in the last y number of trips is significantly higher than the frequency of occurrence of an anomaly which is a processing target in the past x number of trips.

In a case in which the determination of step 150 is affirmative, since the anomaly which is the processing target can be determined to be a communication anomaly caused by an fraud such as a cyber attack as illustrated in FIG. 10, processing such as recording information indicating that an anomaly which is a processing target is an anomaly caused by fraud such as a cyber attack is performed, and the processing returns to step 136. In a case in which the determination of step 152 is negative, since the anomaly which is the processing target can be determined to be a communication anomaly caused by a change in the communication specification in the network 11 (i.e., a communication anomaly due to not conforming to the communication specification after the change), the processing transitions to step 142, and processing such as adding the anomaly which is a processing target to the erroneous detection learning result is performed.

In this manner, in the second exemplary embodiment, the erroneous detection learning section 44 determines whether or not there is a significant difference between the frequency with which a communication anomaly is detected by the communication anomaly detection section 34 in the first period of time and the frequency with which a communication anomaly is detected by the communication anomaly detection section 34 in the second period of time, using a t-test or a u-test. This enables accurate determination of whether or not there is a significant difference between the frequency with which a communication anomaly is detected in the first period of time and the frequency with which a communication anomaly is detected in the second period of time, enabling the accuracy of anomaly detection to be improved.

Note that in the above exemplary embodiments, explanation has been given regarding a configuration in which the second timing is a timing prior to the present time by y number of trips, and the first timing is a timing prior to the second timing by x number of trips. However, the present disclosure is not limited thereto. For example, the second timing may be a timing prior to the present time by a predetermined time, and the first timing may be a timing prior to the second timing by a predetermined time. Further, for example, the second timing may be a timing prior to the present time by an amount of time it takes for a predetermined number of frames to be communicated in the network 11, and the first timing may be a timing prior to the second timing by an amount of time it takes for a predetermined number of frames to be communicated in the network 11. In addition, for example, the first timing may be a timing immediately after a change in the communication specification in the network 11 has been detected by the erroneous detection learning section 44.

In the above exemplary embodiments, explanation has been given regarding an aspect in which the determination as to whether or not a communication anomaly detected by the communication anomaly detection section 34 is an anomaly is performed by comparing the frequencies with which a communication anomaly has been detected during the first period of time and the second period of time with threshold values (the first exemplary embodiment) or determining whether or not there is a significant difference between the frequencies with which a communication anomaly has been detected in the first period of time and the frequency with which a communication anomaly has been detected in the second period of time, using a t-test or a u-test (the second exemplary embodiment). However, the present disclosure is not limited to this, and the determination performed by the determination section in the present disclosure may be performed by applying, for example, Artificial Intelligence (AI) technology.

More specifically, as an example, learning is performed using learning data (training data) in which a timing at which the communication specification has been changed (such as a time or a counter value) and a detection timing of a communication anomaly in the network 11 are input values, and whether or not a communication anomaly should ultimately be determined is an output value. Further, the timing to change the communication specification and the detection timing of a communication anomaly may be used as input values, and based on the determination model acquired through the above learning, whether or not to ultimately determine a communication anomaly may be determined. Moreover, the learning described above is not limited to supervised learning, and unsupervised learning may be applied to classify the presence or absence of an anomaly.

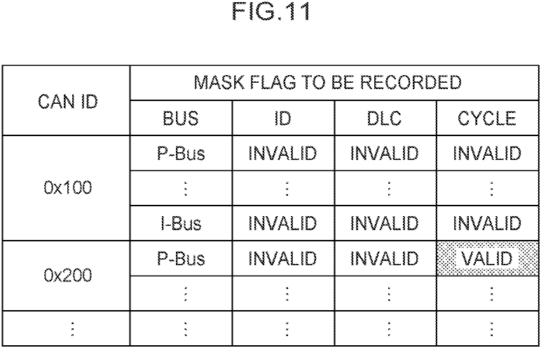

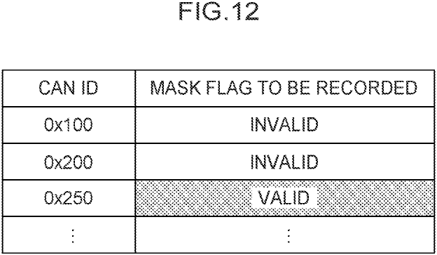

Although the configuration illustrated in FIG. 4 has been described as an example of the erroneous detection learning result 40 in the above exemplary embodiments, there is no limitation thereto. For example, the erroneous detection learning result illustrated in FIG. 11 is configured so as to allow a mask (flag) to be set for each data type of CAN ID, CAN communication bus, ID, DLC, or cycle. In the example illustrated in FIG. 11, in a case in which it is determined that an erroneous detection of a communication anomaly has occurred, the mask (flag) for the corresponding CAN ID, the corresponding CAN communication bus, or the corresponding data type is changed to “valid”. Further, for example, the erroneous detection learning result illustrated in FIG. 12 is configured such that a mask (flag) can be set for each CAN ID, and in a case in which it is determined that erroneous detection of a communication anomaly has occurred, the mask (flag) for to the corresponding CAN ID is changed to “valid”. The erroneous detection learning result 40 may be configured as illustrated in FIG. 11 or FIG. 12.

Although explanation has been given regarding an aspect in which an anomaly in an ID, an anomaly in a DLC, or an anomaly in a transmission interval of a CAN communication frame are each detected as a communication anomaly in the above exemplary embodiments, there is no limitation thereto, and one or more anomaly selected from among an anomaly in an ID, an anomaly in a DLC, or an anomaly in a transmission interval may be detected.

Although CAN communication has been described as an example of communication in the onboard system 12 in the above exemplary embodiments, the present disclosure is not limited to CAN communication, and may be applied to other known communication such as LIN or FlexRay, for example.

Further, although explanation has been given regarding an aspect in which the anomaly detection program 28, which is an example of a program according to the present disclosure, is stored (installed) in advance in the storage section 20 in the above exemplary embodiments, the program according to the present disclosure may be provided in a format recorded on a non-transitory recording medium such as an HDD, an SSD, or a DVD.

What is claimed is:

1. An information processing device, comprising:
a memory; and
a processor coupled to the memory, the processor being configured to:
detect a communication anomaly of communication in a network, based on a predetermined rule,
detect a change in a communication specification in the network, and
determine whether or not there is an anomaly in the communication based on whether or not a first frequency with which the communication anomaly is detected in a first period of time that is from a first timing until a second timing that is after the first timing, is less than a second frequency with which the communication anomaly is detected in a second period of time that is from the second timing onward, the first timing being on or after a time at which the change in the communication specification is detected.

2. The information processing device according to claim 1, wherein the processor is configured to:
determine that there is no anomaly in a case in which the first frequency with which the communication anomaly is detected in the first period of time exceeds a first threshold value, and
determine that there is an anomaly in a case in which the second frequency with which the communication anomaly is detected in the second period of time after the first period of time exceeds a second threshold value that is equal to or greater than the first threshold value.

3. The information processing device according to claim 1, wherein the processor is configured to:
determine that there is no anomaly in a case in which the first frequency with which the communication anomaly is detected on or after the first timing exceeds a first threshold value, the first timing being immediately after the change in the communication specification is detected, and
determine that there is an anomaly in a case in which the second frequency with which the communication anomaly is detected on or after the second timing exceeds a second threshold value that is equal to or greater than the first threshold value.

4. The information processing device according to claim 1, wherein the processor is configured to determine whether or not there is a significant difference between the first frequency with which the communication anomaly is detected in the first period of time and the second frequency with which the communication anomaly is detected in the second period of time, by a t-test or a u-test.

5. The information processing device according to claim 1, wherein the predetermined rule is an identical rule before and after the change in the communication specification is detected by the processor.

6. The information processing device according to claim 1, wherein the processor is configured to set information relating to communication not determined to be an anomaly as a suppression target to which detection of a communication anomaly is suppressed.

7. The information processing device according to claim 1, wherein the processor is configured to detect, as the change in the communication specification, replacement of an ECU that is included in the network or an update of a program that is stored in the ECU.

8. The information processing device according to claim 1, wherein the second timing is one of: a timing that is prior to a present time by a predetermined period of time, a timing that is prior to the present time by an amount of time it takes for a predetermined number of frames to be communicated in the network, or a timing that is prior to the present time by an amount of time it takes for a number of trips to reach a first predetermined value.

9. The information processing device according to claim 1, wherein the first timing is one of: a timing immediately after the change in the communication specification is detected, a timing that is prior to the second timing by a predetermined period of time, a timing that is prior to the second timing by an amount of time it takes for a predetermined number of frames to be communicated in the network, or a timing that is prior to the second timing by an amount of time it takes for a number of trips to reach a second predetermined value.

10. A vehicle comprising the information processing device according to claim 1.

11. An information processing method, comprising:
detecting a communication anomaly of communication in a network, based on a predetermined rule,
detecting a change in a communication specification in the network, and
determining whether or not there is an anomaly in the communication based on whether or not a first frequency with which the communication anomaly is detected in a first period of time that is from a first timing until a second timing that is after the first timing, is less than a second frequency with which the communication anomaly is detected in a second period of time that is from the second timing onward, the first timing being on or after a time at which the change in the communication specification is detected.

12. A non-transitory storage medium storing a program executable by a computer to perform information processing, the information processing comprising:
detecting a communication anomaly of communication in a network, based on a predetermined rule,
detecting a change in a communication specification in the network, and
determining whether or not there is an anomaly in the communication based on whether or not a first frequency with which the communication anomaly is detected in a first period of time that is from a first timing until a second timing that is after the first timing, is less than a second frequency with which the communication anomaly is detected in a second period of time that is from the second timing onward, the first timing being on or after a time at which the change in the communication specification is detected.
